(19) United States
(12) Patent Application Publication
(10) Pub. No.: US 2007/0092282 A1
(43) Pub. Date: Apr. 26, 2007

(54) Image forming device

(76) Inventor: Hideya Takenoshita, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,104

(22) Filed: Oct. 26, 2005

(51) Int. Cl. G03G 15/00

(52) U.S. Cl. 399/81

(57) ABSTRACT

An image forming device of the invention is provided with a user setting storage portion for storing a user settings relating to the execution of an image formation job, a temporary save key for making a command to the user setting storage portion to store the user settings, a user setting memory control portion for storing the user settings on the user setting storage portion when a command has been made through the temporary save key, a recall key for making a command to display the identifying information of the user settings stored on the user setting storage portion, a user setting selection control portion for, when a command has been made through the recall key, displaying the identifying information of a user setting stored on the user setting storage portion and setting the setting values included in the user setting of the displayed identifying information to the device, and a recording portion for executing image formation jobs.

### FIELD OF THE INVENTION

The present invention relates to image forming devices that allow print conditions, etc. to be set.

### BACKGROUND INFORMATION

Some conventional image forming devices, such as copier machines, include a user setting registration (job registration) function for registering frequently used settings, such as the print conditions, on that image forming device. For example, patent document 1 proposes an image forming device that is provided with a plurality of job registration keys and that allows user settings to be registered and called up with the touch of a single button by assigning user settings to those job registration keys.

However, one problem with such user setting registration is that it is necessary to provide a job registration key for each assignment, and thus it is not possible to register more user settings than there are job registration keys. Another problem is that providing a large number of job registration keys complicates the control section.

The invention was arrived at in light of the foregoing problems, and it is an object thereof to provide an image forming device with which more user settings can be registered with fewer operation keys.

### SUMMARY OF THE INVENTION

An image forming device according to a first aspect is provided with user setting storage means that stores a user setting consisting of setting values for at least one predetermined setting field, relating to execution of an image formation job, store command means that consists of one operation key and that is for an operator to make a command for the user setting storage means to store the user setting, store control means for storing the user setting on the user setting storage means when the command has been received from the store command means, display command means that consists of one operation key and that is for the operator to make a command to display identifying information of the user setting stored on the user setting storage means, display control means for displaying the identifying information of the user setting stored on the user setting storage means when a command has been received through the display command means, setting means for setting, to a device, the setting values included in the user setting of the identifying information displayed by the display control means, and image formation job executing means for executing the image formation job that has been set by the setting means.

With this configuration, when executing an image formation job, an operator can store a user setting related to the settings of the image formation conditions of that image formation job on the device at the touch a single operation key, and then the operator, using one or more operation keys, can set a desired user setting, from among the user settings that are stored on the device, to the device with a single touch of a button or through relatively few operations. Thus, an operator can store user settings on the device and call up those user settings and set them to the device without using a complex control portion and without performing time consuming operations.

The image forming device according to a second aspect is the image forming device according to the first aspect, in which the display control means displays the identifying information of a plurality of the user settings when a plurality of the user settings are stored in the user setting storage means, the image forming device further includes selection means for the operator to select one user setting from the identifying information of the plurality of user settings that are displayed by the display control means, and the setting means sets, to the device, the setting values included in the user setting that has been selected by the selection means.

With this configuration, the identifying information of a plurality of user settings are displayed at once, and the operator can select one user setting from among these, and thus if many user settings have been stored, it is possible to set a stored user setting to the device through fewer operations without using a complex control portion.

The image forming device according to a third aspect is the image forming device according to the first aspect, further including erasing means for erasing the user setting stored in the user setting storage means when the image forming device is powered off.

With this configuration, the user settings stored on the user settings storage means are erased when the image forming device is powered off, and thus a region for storing new user settings is secured each time the device is powered off and it is not necessary for the operator to be concerned about the maximum limit of the region for storing user settings.

The image forming device according to a fourth aspect is the image forming device according to the first aspect, further including order obtaining means for obtaining an order in which the user settings were stored on the user setting storage means, wherein the store control means stores the order that is obtained by the order obtaining means on the user setting storage means in association with the user settings, and the display control means displays the identifying information of the user settings sequentially starting from the most recent user setting in the order.

With this configuration, the identifying information of the user settings is displayed in order from the most recently stored user setting, so that the more recently a user setting is stored, the fewer operations required to set it to the device, and thus more recently stored user settings, which are more likely to be set to the device, can be set to the device even simpler operation.

The image forming device according to a fifth aspect is the image forming device according to the fourth aspect, in which the store control means erases the oldest user setting of the order if there is insufficient storage space in the user setting storage means when the user setting is to be stored on the user setting storage means.

With this configuration, when there is insufficient storage space for storing a user setting in the device, the user settings are erased in order from the oldest stored user setting and thus stored user settings that are old, which conceivably have a relatively low likelihood of being used, are erased first, and therefore new user settings can be stored without sacrificing user convenience.

The image forming device according to a sixth aspect is the image forming device according to the fourth aspect, in which the order obtaining means is a clock means for taking time, the storage control means stores the user settings on the user setting storage means along with a time that is taken by the clock means when the user setting is stored, and the display control means displays at least the time that is associated with that user setting as identifying information of the user setting.

With this configuration, the time at which a user setting is stored is displayed as identifying information of the user setting, and thus an operator can search for a target user setting based on the time that the user setting was stored.

The image forming device according to a seventh aspect is the image forming device according to the fifth aspect, in which the display control means displays the time as identifying information of the user setting, and then erases that display of the time after a predetermined period of time has elapsed.

With this configuration, the display of the time is erased after a predetermined amount of time has elapsed, and thus a new display area the size of the erased region can be secured and this allows more/other information to be displayed.

The image forming device according to an eighth aspect is the image forming device according to the first aspect, further including a non-volatile protective storage means for storing the user settings stored on the user setting storage means for backup, and a protective storage control means for causing the protective storage means to store the user settings that are stored on the user setting storage means.

With this configuration, the user settings stored on the user setting storage means are also stored on a nonvolatile protective storage means, and thus even if a user setting stored on the user setting storage means is erased, that user setting can be called up and restored in the user setting storage means.

The image forming device according to a ninth aspect is the image forming device according to the first aspect, further including erase prohibit specifying means for an operator to specify user settings that are to be prohibited from being erased by the store control means, and adding means for adding an erase prohibit flag to the user settings that have been specified by the erase prohibit specifying means, wherein the store control means does not erase user settings to which an erase prohibit flag has been added.

With this configuration, user settings that have been specified as erase prohibited will not be erased in order to secure storage space.

The image forming device according to a tenth aspect is the image forming device according to the ninth aspect, in which the maximum number of user settings to which the adding means can add an erase prohibit flag is one less than a number of user settings that can be stored on the user setting storage means.

With this configuration, it is possible to obviate the problem of not being able to secure storage space for registering a new user setting due to all of the storable user settings being specified as erase prohibited.

With the invention according to the first aspect, when executing an image formation job, an operator can store a user setting related to the settings of the image formation conditions of that image formation job on the device at the touch a single operation key, and then the operator, using one or more operation keys, can set a desired user setting, from among the user settings that are stored on the device, to the device with a single touch of a button or through relatively few operations. Thus, an operator can store user settings on the device and call up those user settings and set them to the device without using a complex control portion and without performing time consuming operations.

With the invention according to the second aspect, the identifying information of a plurality of user settings are displayed at once, and the operator can select one user setting from among these, and thus if many user settings have been stored, it is possible to set a stored user setting to the device through fewer operations without using a complex control portion.

With the invention according to the third aspect, the user settings stored on the user settings storage means are erased when the image forming device is powered off, and thus a region for storing new user settings is secured each time the device is powered off and it is not necessary for the operator to be concerned about the maximum limit of the region for storing user settings.

With the invention according to the fourth aspect, the identifying information of the user settings is displayed in order from the most recently stored user setting, so that the more recently a user setting is stored, the fewer operations required to set it to the device, and thus more recently stored user settings, which are more likely to be set to the device, can be set to the device with even simpler operation.

With the invention according to the fifth aspect, when there is insufficient storage space for storing a user setting in the device, the user settings are erased in order from the oldest stored user setting and thus stored user settings that are old, which conceivably have a relatively low likelihood of being used, are erased first, and therefore new user settings can be stored without sacrificing user convenience.

With the invention according to the sixth aspect, the time at which the user setting is stored is displayed as identifying information of that user setting, and thus an operator can search for a target user setting based on the time that the user setting was stored.

With the invention according to the seventh aspect, the display of the time is erased after a predetermined amount of time has elapsed, and thus a new display area the size of the erased region can be secured and this allows more/other information to be displayed.

With the invention according to the eighth aspect, the user settings stored on the user setting storage means are also stored on a nonvolatile protective storage means, and thus even if a user setting stored on the user setting storage means is erased, that user setting can be called up and restored in the user setting storage means.

With the invention according to the ninth aspect, user settings that have been specified as erase prohibited will not be erased in order to secure storage space.

With the invention according to the tenth aspect, it is possible to obviate the problem of not being able to secure storage space for registering a new user setting due to all of the storable user settings being specified as erase prohibited.

### BRIEF DESCRIPTION OF THE SEVERAL VIEWS OF THE DRAWINGS

FIG. 1 is a lateral schematic view showing the mechanical configuration of the image forming device according to an embodiment of the invention.

FIG. 2 is a block diagram showing the functional configuration of the image forming device according to an embodiment of the invention.

FIG. 3A and FIG. 3B are diagrams showing an example of the copy conditions setting screen on the touch panel portion according to an embodiment of the invention, where FIG. 3A shows the basic screen and FIG. 3B shows a screen listing all of the setting fields.

FIG. 4A and FIG. 4B show an example of the user setting selection screen of touch panel portion according to an embodiment of the invention, the where FIG. 4A shows a first page and FIG. 4B shows a second page.

FIG. 5 shows the information stored on the user setting registration storage portion according to an embodiment of the invention.

FIG. 6 is a flowchart showing the flow of the processing of the image forming device according to an embodiment of the invention.

FIG. 7 is a flowchart showing the flow of the processing of the image forming device according to an embodiment of the invention.

FIG. 8 is a flowchart showing the flow of the processing of the image forming device according to an embodiment of the invention.

### DETAILED DESCRIPTION OF THE PREFERRED EMBODIMENTS

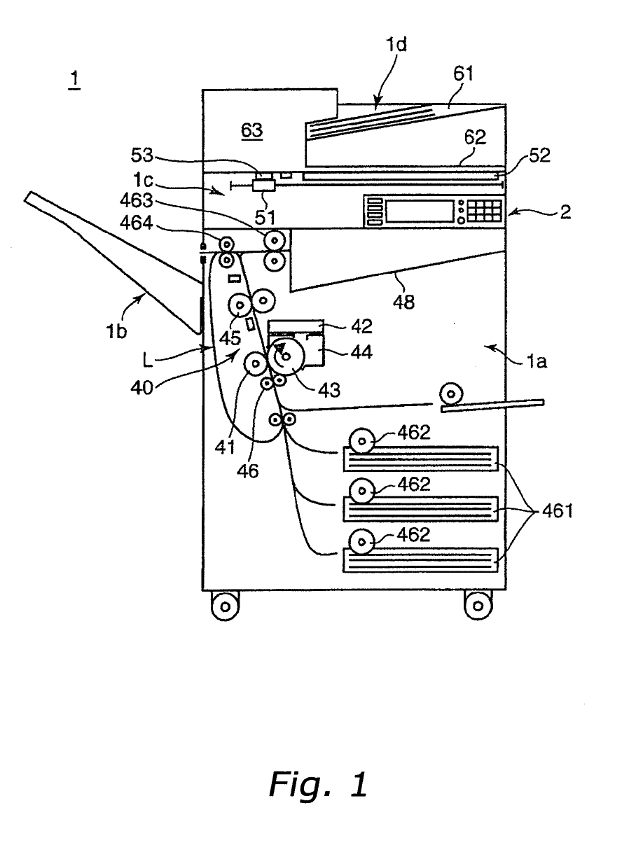

An image forming device according to an embodiment of the invention is described below with reference to the drawings. FIG. 1 is a lateral view that schematically shows the internal structure of a copier machine, which serves as an example of the image forming device according to an embodiment of the invention. A copier machine 1 has a main unit 1a, a stack tray 1b that is disposed to the left of the main unit 1a, an original document reading portion 1c that is disposed at an upper portion of the main unit 1a, and an original document feeding portion 1d that is disposed above the original document reading portion 1c.

A operation portion 2 is provided in a front portion of the copier machine 1. The original document reading portion 1c is provided with a scanner portion 51 that is made of a CCD (Charge Coupled Device) sensor and an exposure lamp, for example, an original document platen 52 that is made of a transparent member such as glass, and an original document reading slit 53. The scanner portion 51 can be moved by a drive portion that is not shown, and when reading an original document that has been placed on the original document platen 52, the scanner portion 51 is moved over the surface of the original document at a position that is in opposition to the original document platen 52, scanning the original document image and at the same time outputting the obtained image data to an image formation control portion (not shown). When reading an original document that has been fed by the original document feeding portion 1d, the scanner portion 51 is moved to a position that is in opposition to the original document reading slit 53 and obtains an image of the original document through the original document reading slit 53 in synchronization with the operation for carrying the original document by the original document feeding portion 1d, and outputs that image data to the image formation control portion.

The original document feeding portion 1d is provided with an original document reception portion 61 for receiving original documents, an original document discharge portion 62 for discharging original documents whose image has been read, and an original document carrying mechanism 63 that is made of feed rollers (not shown) and carry rollers (not shown) that draw out the original document placed on the original document reception portion 61 one sheet at a time and carry it to a position that is in opposition to the original document reading slit 53 and then discharge it to the document discharge portion 62. The original document carrying mechanism 63 is also provided with a paper inversion mechanism (not shown) that flips over the original document and carries it to a position that is in opposition to the original document reading slit 53, allowing images on both sides of the original document to be read from the scanner portion 51 through the original document reading slit 53.

The original document feeding portion 1d is provided in such a manner that it can rotate about the main unit 1a so that its front surface side can be moved upward. Moving the front surface side of the original document feeding portion 1d upward to expose the upper surface of the original document platen 52 allows the operator to place an original document to be read, such as an open book, on the upper surface of the original document platen 52.

The main unit 1a is provided with a plurality of feed cassettes 461, each of which stores different types and sizes of recording paper (such as normal paper that can be printed on both sides, and reusable paper that can be printed on one side only), a feed roller 462 that carries the recording paper from the feed cassettes 461 to a recording portion 40 one sheet at a time, and the recording portion 40, which forms an image on the recording paper that has been carried from the feed cassettes 461. It should be noted that the image formation control portion stores information on the type and size of the paper stored in each feed cassette 461, and when an operator sets a paper type to use for printing, the recording paper is fed from the feed cassette 461 that stores that type of paper.

The recording portion 40 is provided with an optical unit 42 that outputs a laser light, for example, to expose a photosensitive drum 43 based on the image data that are obtained by the scanner portion 51, a developing portion 44 that forms a toner image on the photosensitive drum 43, a transfer portion 41 that transfers the toner image on the photosensitive drum 43 to the recording paper, a fixing portion 45 for heating the recording paper to which the toner image has been transferred to fix the toner image on the recording paper, and carry rollers 463 and 464, provided on the path over which the paper is carried in the recording portion 40, that carry the recording paper to either the stack tray 1b or the discharge tray 48.

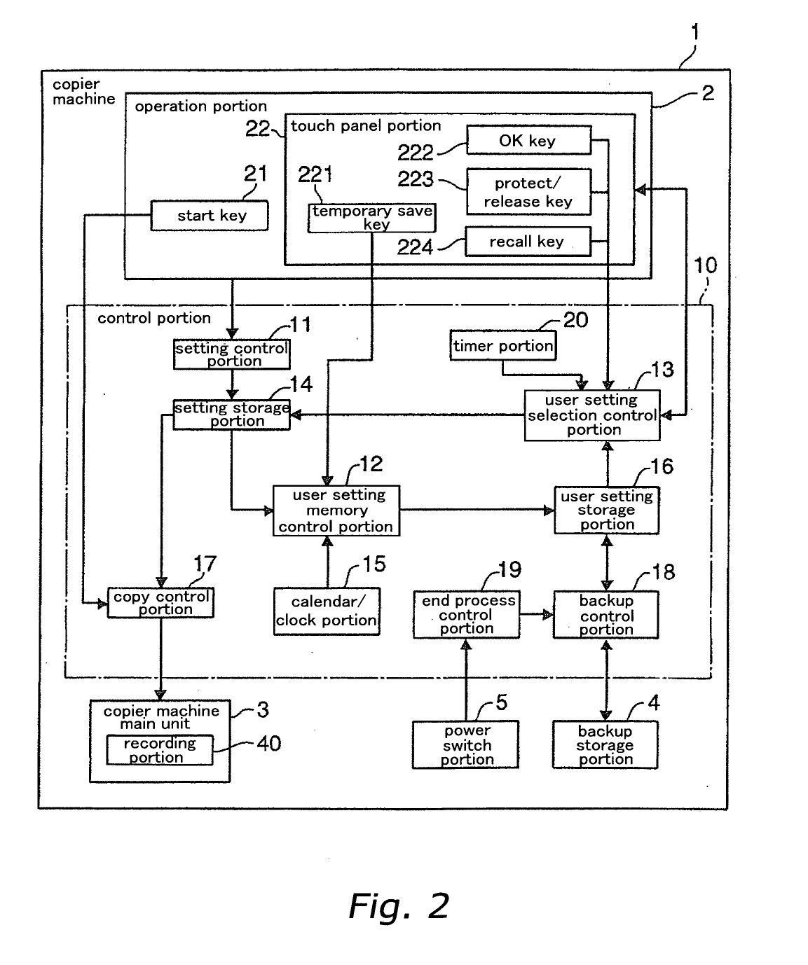

FIG. 2 is a block diagram showing the functional configuration of the copier machine 1 of the embodiment. The copier machine 1 is provided with the operation portion 2, a control portion 10, a copier machine main unit 3, a backup storage portion 4, and the power switch portion 5. Here, the copier machine main unit 3 is everything other than the operation portion 2, the control portion 10, the backup storage portion 4, and a power switch portion 5 in the copier machine 1. The backup storage portion 4 is a nonvolatile memory device, and for example is a HDD (hard disk drive). The power switch portion 5 provides a power switch for the copier machine 1 that is actuated by the operator, and when the power switch is turned on, power is supplied to the copier machine 1, and when turned off, a communication indicating this is sent to an end process control portion 19.

The operation portion 2 is the operation user interface of the copier machine 1, and is provided with at least a start key 21 and a touch panel portion 22. The start key 21 is a button for making the command to start printing. The touch panel portion 22 is a touch panel display.

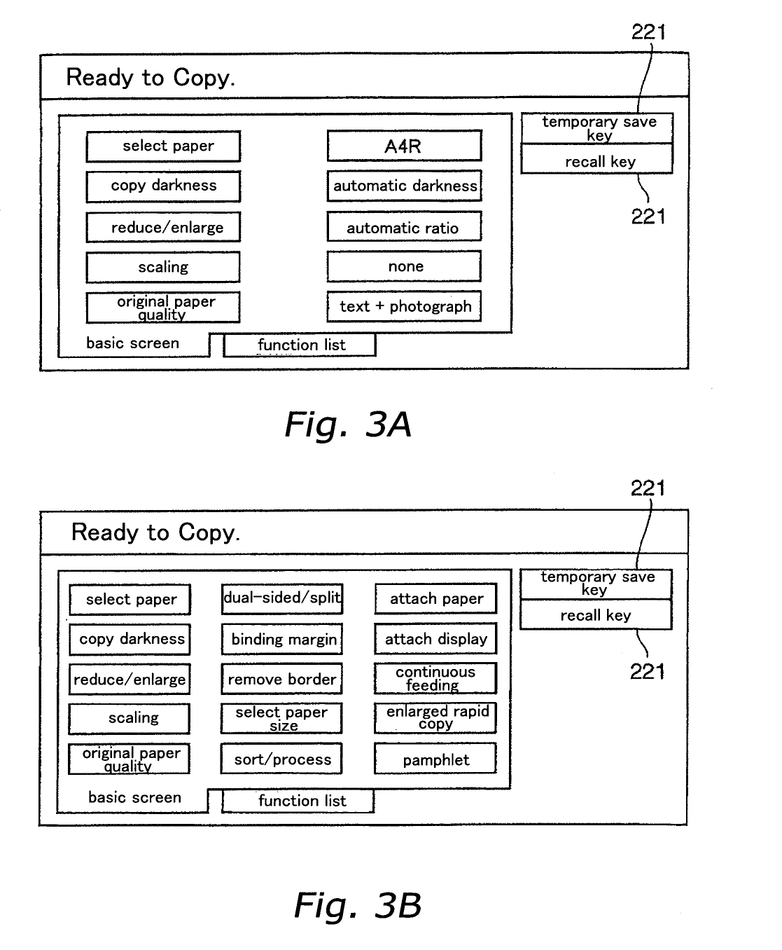

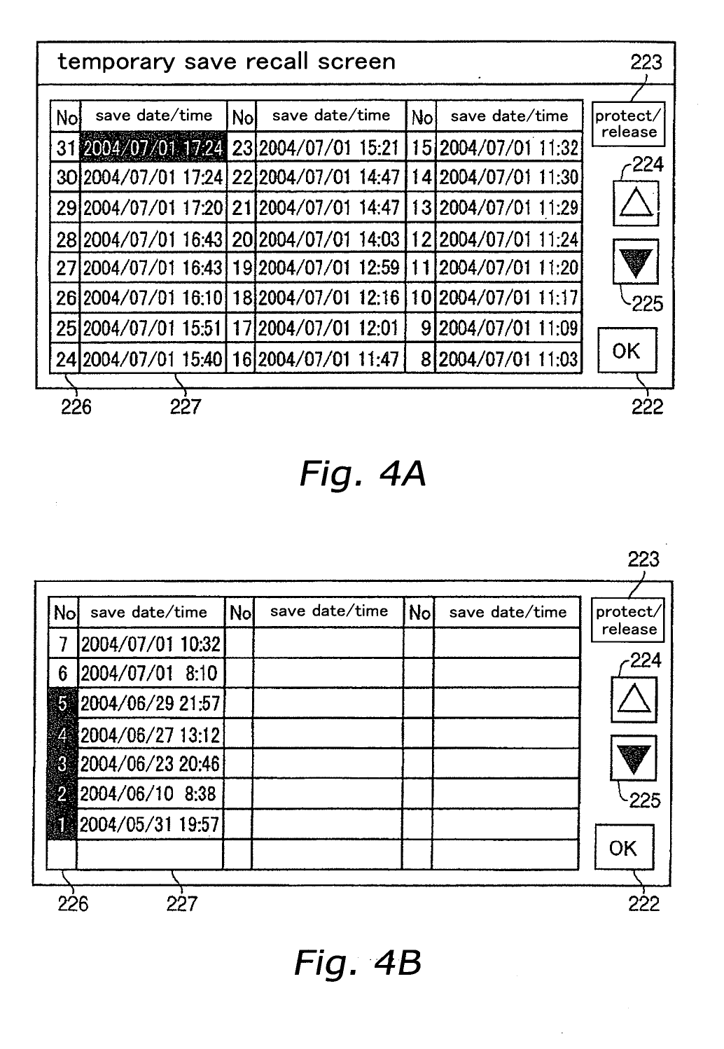

The operations using the operation portion 2 relating to the user setting registration in the embodiment is described here. FIGS. 3A and 3B are the copy condition setting screens of the touch panel portion 22. FIG. 3A is the basic screen of the copy condition settings (the screen showing only those copy conditions that are used frequently) and FIG. 3B is a function list screen that displays all of the copy condition setting fields. In both screens, by touching a setting field item that is displayed, it is possible to adjust the settings of that setting field. Both copy condition setting screens include a temporary save key 221 and a recall key 224. When the temporary save key 221 is touched, the copy conditions that have been set at that point are registered on the copier machine 1 (the operation within the copier machine 1 relating to this registration is discussed later). Here, setting refers to storing setting values for immediate use in the device, and registering refers to storing setting values to be called up for future use on the device. When the recall key 224 is touched, the screen of the touch panel portion 22 is switched to the user setting selection screen shown in FIG. 4A.

FIGS. 4A and 4B are user setting selection screens, where FIG. 4A is page 1 and FIG. 4B is page 2. These screens include a list number 226 and a save date 227 as items for identifying the user settings, and a protect/release key 223, an up arrow key 224, a down arrow key 225, and an OK key 222 for operation. Hereinafter, the above list of user setting markings will be referred to as a selection list. The selection list displays the items arranged by most recent save date, for example. The list numbers 226 assign a number in the order of oldest save date, for example. Thus, the list number 226 of the user setting shown at the top indicates the number of user settings that have been registered.

When the up arrow key 224 is touched, the screen is moved to the previous page of the selection list, and when no previous page exists, the up arrow key 224 is displayed lighter in color and input to the up arrow key 224 is disregarded, for example. When the down arrow key 225 is touched, the screen is moved to the next page of the selection list, and when no next page exists, the down arrow key 225 is displayed lighter in color and input to the down arrow key 225 is disregarded, for example. When an item of the selection list is touched, then, as shown by the item of the list number 226 “31” in FIG. 4A, the save date region of that item is black-white inverted to indicate that the user setting has been selected. When the OK key 222 is touched at this time, the contents of the selected user setting (copy conditions) are set to the copier machine 1. Touch input to the OK key 222 is recognized only when a single user setting has been selected.

When the protect/release key 223 is touched after a user setting has been selected from the selection list, the contents of the selected user setting are protected from being erased. If this operation is performed for user settings that have already been protected, then that protection is released. The list number 226 region in protected user settings is black-white inverted like the region of list numbers 226 “1” to “5” in FIG. 4B.

Returning to FIG. 2, the operation portion 2 notifies a copy control portion 17 when the start key 21 has been pressed. The operation portion 2 notifies a user setting memory control portion 12 when the temporary save key 221 has been pressed. When the recall key 22 is touched, the operation portion 2 transmits this information to a user setting selection control portion 13. The operation portion 2 notifies the user setting selection control portion 13 when a user setting on the selection list has been selected or that selection has been released. The operation portion 2 notifies the user setting selection control portion 13 when the OK key 222 has been pressed. The operation portion 2 notifies the user setting selection control portion 13 when the protect/release key 223 has been pressed. The operation portion 2 notifies the setting control portion 11 when settings of the various copy condition settings are input.

The control portion 10 is described next. The control portion 10 performs overall control of the copier machine 1, and for example is made of a CPU (central processing unit), a RAM (random access memory), and a ROM (read only memory). The control portion 10 is provided with the setting control portion 11, the user setting memory control portion 12, the user setting selection control portion 13, a setting storage portion 14, a calendar/clock portion 15, a user setting storage portion 16, the copy control portion 17, a backup control portion 18, the end process control portion 19, and a timer portion 20.

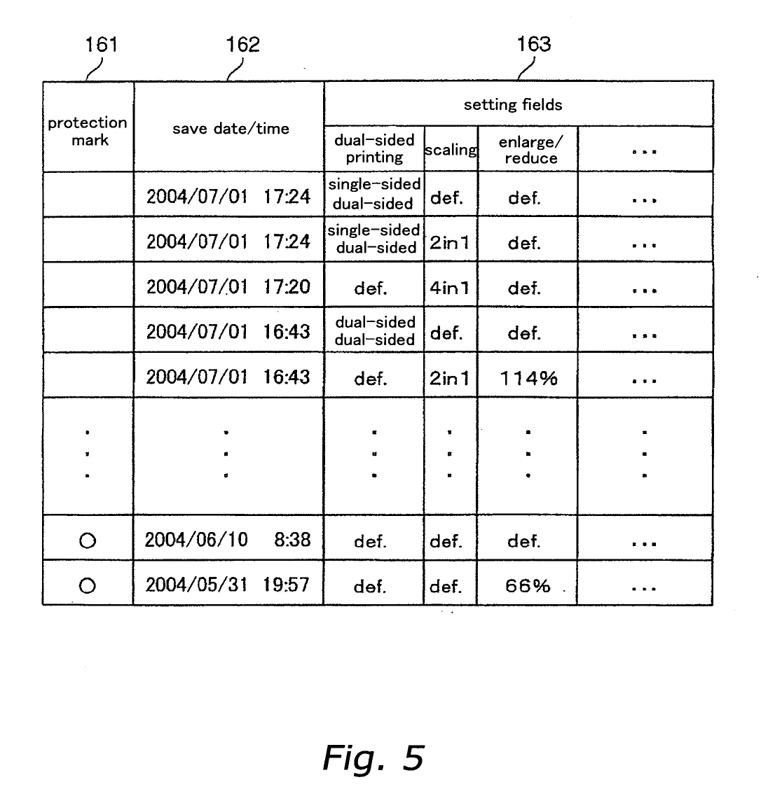

The setting storage portion 14 stores the current setting values of the various copy conditions (such as dual-sided printing, scaling, etc.) to the copier machine 1. The setting control portion 11 receives the input of setting values for the various copy conditions that has been made using the operation portion 2, and writes these to the setting storage portion 14. The user setting storage portion 16 is for storing user settings that have been registered to the copier machine 1. The user setting storage portion 16 is a volatile memory (such as a RAM) whose stored content is erased when the copier machine 1 is powered off. The user setting storage portion 16 stores the user setting list shown in FIG. 5 in order to store user settings. A protection mark, such as an “O,” is written to a protection mark column 161 of the user setting list if the user settings of that row have been protected. The date/time when the user settings of that row were registered is written to a save date/time column 162. The setting values for all of the setting fields of the copy conditions (such as those displayed on the screen of FIG. 3B) are written to a setting field column 163. When the setting is the default value, “def.” is entered. The calendar/clock portion 15 is for keeping the current date and time. The timer portion 20 measures the time that has elapsed from the start of a time measurement.

When it has received notification that the temporary save key 221 has been touched, the user setting memory control portion 12 writes the settings of the copy conditions that are stored on the setting storage portion 14 to the user setting storage portion 16. At this time, the user setting memory control portion 12 obtains the date and time at that point from the calendar/clock portion 15, and writes these associated with the setting values. The protection mark column 161 is blank.

When it has received notification that the recall key 224 has been touched, the user setting selection control portion 13 reads the user settings that are stored on the user setting storage portion 16 and displays a user setting selection screen (see FIGS. 4A and 4B) on the touch panel portion 22. When the user setting selection control portion 13 receives notification that an item on the selection list has been touched, it sets that user setting to the selected state if the user setting of that item is not in the selected state, and deselects that user setting if the user setting that has been touched is in the selected state. The user setting selection control portion 13 stores the current selection state. When the user setting selection control portion 13 receives notification that the OK key 222 has been touched, it reads the setting values of the user setting that is currently in the selected state from the user setting storage portion 16 and writes them to the setting storage portion 14. When the user setting selection control portion 13 receives notification that the protect/release key 223 has been touched, it reverses the protection state of the user setting that is currently in the selected state. That is to say, for a user setting that is protected, it removes the protection display from the selection list (black-white inverts the list number 226 region) and erases the protection mark in the protection mark column 161 of the row of that user setting that is stored in the user setting storage portion 16. For a user setting that is not protected, it adds a protection display to the display of the selection list, and writes a protection mark to the protection mark column 161 of the row of that user setting that is stored in the user setting storage portion 16.

The end process control portion 19 controls the end processes that should be performed before the copier machine 1 is powered off. The backup control portion 18 writes the user settings provided with a protection mark, of those stored on the user setting storage portion 16, to the backup storage portion 4. To initialize the control portion, the backup control portion 18 writes the user settings that are stored on the backup storage portion 4 to the user setting storage portion 16 and writes a protection mark to the protection mark column 161 of the row for those user settings.

The copy control portion 17 performs control for executing copying when it has received notification from the operation portion 2 that the start key 21 has been pressed. At this time, the copy control portion 17 reads the setting values for the copy conditions from the setting storage portion 14, and executes copying by controlling the copier machine main unit 3 based on these setting values.

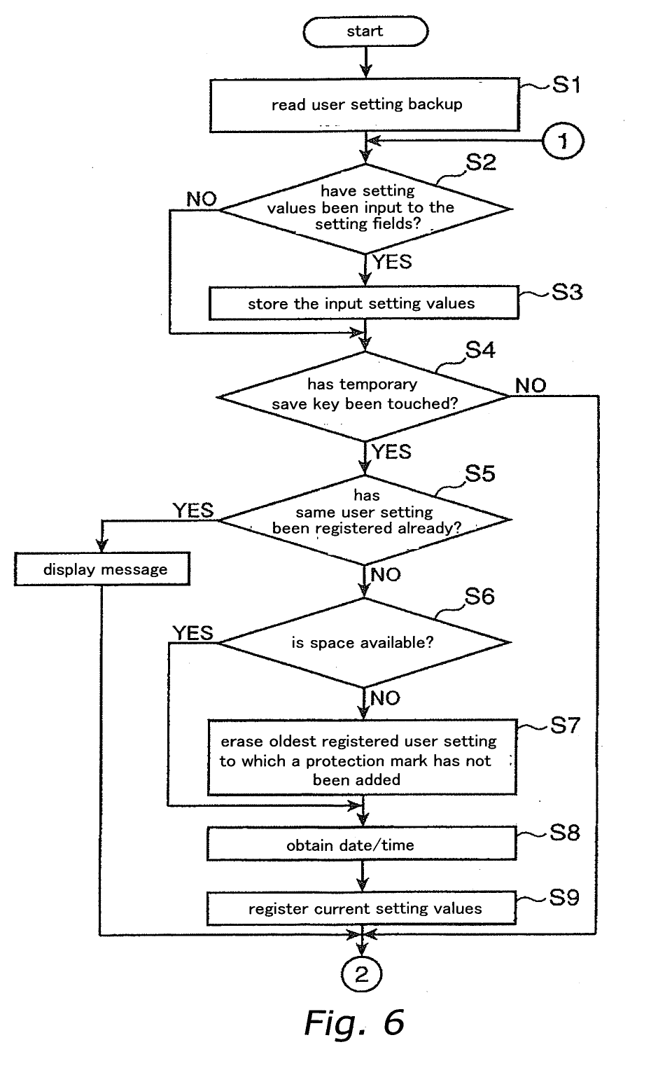

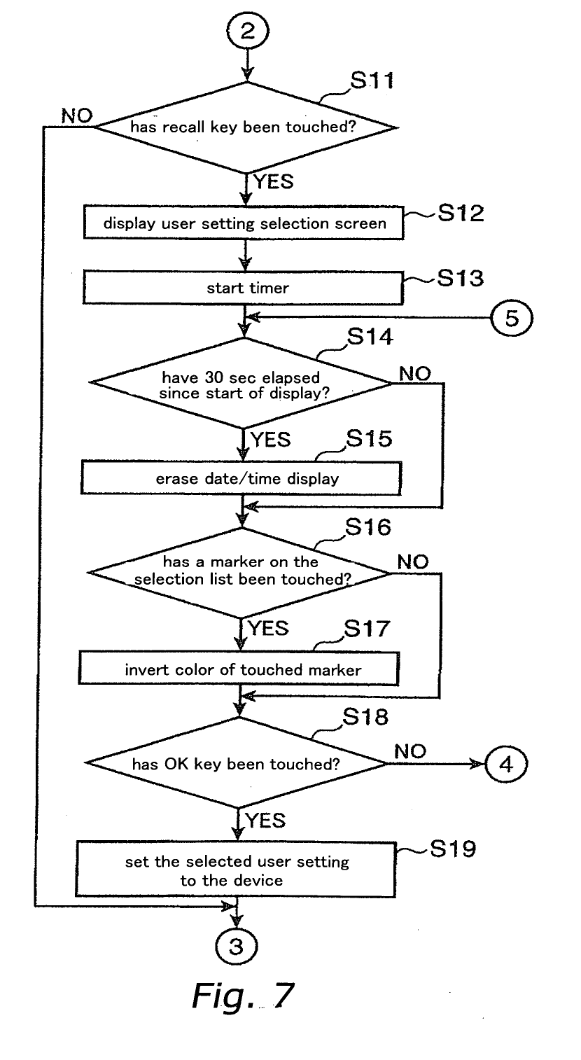

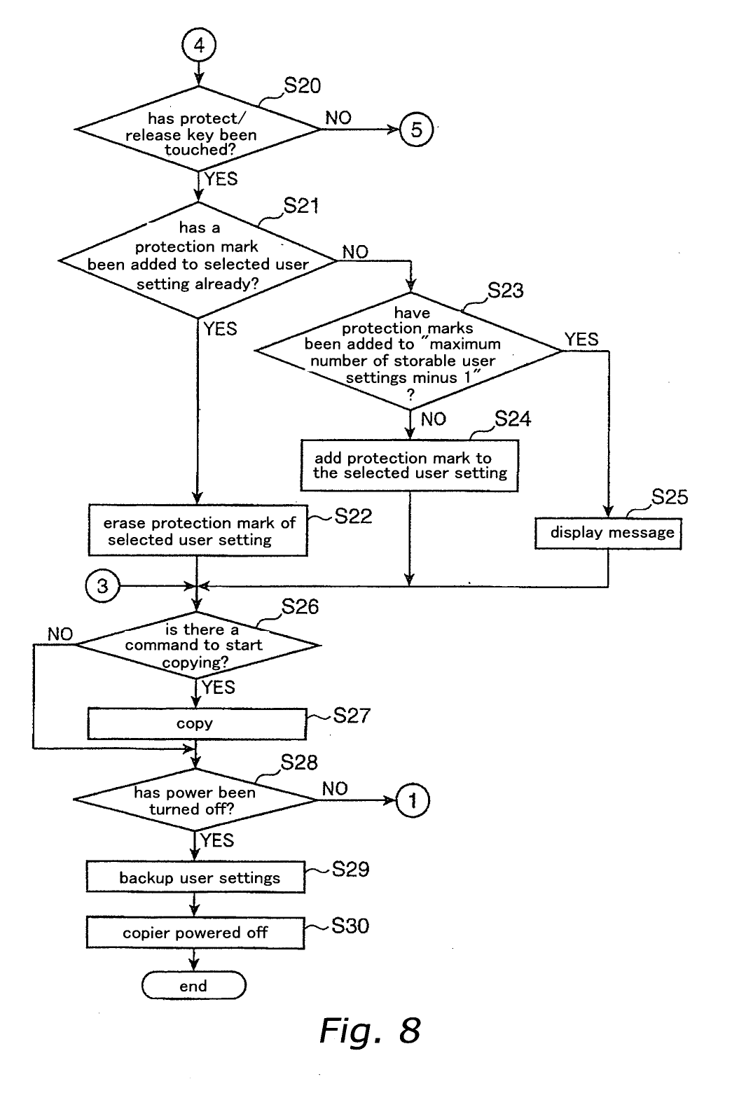

FIGS. 6, 7, and 8 are flowcharts that show the flow of control when registering user settings in the copier machine 1. Step S1 is a user setting backup reading process when the copier machine 1 is turned on. In step S1, as an initializing process for control portion 10 activation when the power switch 5 of the copier machine 1 has been turned on, the backup control portion 18 reads the user settings stored on the backup storage portion 4 from the backup storage portion 4 and writes them to the user setting storage portion 16. At this time, a protection mark is added to the protection mark column 161 of the row for those user settings.

Steps S2 and S3 are processes for setting values for desired copy conditions (setting fields). In step S2, the operation portion 2 checks whether an operator has input a setting value for any of the setting fields (for example, dual-sided printing or scaling), and if such input has been received (YES in step S2), then the procedure is advanced to step S3. In step S3, the operation portion 2 sends the setting value that has been input and the classification of that setting field to the setting control portion 11. The setting control portion 11 writes the setting value that it has received to the column of the appropriate setting field in the setting storage portion 14 in correspondence with that setting field. If the determination at the branch of step S2 is that no setting value has been input for any of the setting fields (NO in step S2), or if the process of step S3 has finished, then the procedure is advanced to step S4.

Steps S4 to S10 are processes for registering user settings. In step S4, the operation portion 2 checks whether the temporary save key 221 has been touched, and if it has been touched (YES in step S4), then the procedure is advanced to step S5. In step S5, the operation portion 2 notifies the user setting memory control portion 12 that the temporary save key 221 has been touched. The user setting memory control portion 12 receives this and then first checks whether a user setting having the same data as the setting value stored on the setting storage portion 14 is already stored in the user setting storage portion 16, and if it already is stored (YES in step S5), then the procedure is advanced to step S10. In step S10, the user setting memory control portion 12 displays a message on the touch panel portion 22 that indicates that the same setting has already been stored. In the branch of step S5, if a same user setting has not been stored (NO in step S5), then the procedure is advanced to step S6. In step S6, the user setting memory control portion 12 checks whether there is capacity to store a new user setting in the user setting storage portion 16, and if there is no capacity (NO in step S6), the procedure is advanced to step S7. In step S7, the user setting memory control portion 12 erases the user setting stored in the user setting storage portion 16 having the oldest save date/time recorded in the save date/time column 162, of the user settings that do not have a protection mark written to their protection mark column 161.

If in the branch of step S6 there is available capacity (YES in step S6), and when the procedure of step S7 is finished, the procedure is advanced to step S8. In step S8, the user setting memory control portion 12 obtains the current date and time from the calendar/clock portion 15. In step S9, the user setting memory control portion 12 creates a new row at the top, for example, of the user setting storage portion 16, and writes the current date and time that have been obtained from the calendar/clock portion 15 in the save date/time column 162 and writes the setting information stored in the setting storage portion 14 (the setting values of the various copy conditions) in the setting field column 163. When the process of step S9 is finished, of when the process of step S10 is finished, the procedure is advanced to step S11.

Steps S11 to S25 are processes for retrieving and protecting user settings. In step S11, the operation portion 2 checks whether the recall key 224 has been touched, and if it has been touched (YES in step S11), then the procedure is advanced to step S12. In step S12, the operation portion 2 notifies the user setting selection control portion 13 that the recall key 224 has been touched. The user setting selection control portion 13 receives this and reads out the user settings from the user setting storage portion 16 and displays the list number 226 and the save date/time 227 as the user setting selection screen on the touch panel 22. In step S13, the user setting selection control portion 13 causes the timer portion 20 to start taking time. In step S14, the user setting selection control portion 13 checks the timer portion 20 to determine whether 30 seconds have elapsed. If 30 seconds have elapsed (YES in step S14), then the user setting selection control portion 13 erases the display of the date and time from the user setting selection screen and updates the display of the user setting selection screen. At this time, it displays more user settings in the space made available in the display region. If it is determined at the branch of step S14 that 30 seconds have not passed (NO in step S14), or if the process of step S15 is finished, then the procedure is advanced to step S16.

In step S16, the operation portion 2 checks whether or not a item on the user setting selection screen has been touched, and if a item has been touched (YES in step S16), then the procedure is advanced to step S17. In step S17, the operation portion 2 notifies the user setting selection control portion 13 that a item on the user setting selection screen has been touched. The user setting selection control portion 13 receives this and inverts the displayed color of the item that has been touched. If the determination at the branch of step S16 is that a item on the selection list has not been touched (NO in step S16), or if the process of step S17 has finished, then the procedure is advanced to step S18.

In step S18, the operation portion 2 checks whether the OK key 222 on the user setting selection screen has been touched, and if it has been touched (YES in step S18), then the procedure is advanced to step S19. At this time, input though the OK key can be received only when a single user setting has been selected. In step S19, the operation portion 2 notifies the user setting selection control portion 13 that the OK key 222 has been touched. The user setting selection control portion 13 receives this communication and reads the setting values of the currently selected user setting (whose item display has been inverted on the user setting selection screen) and writes these to the setting storage portion 14. If the determination at the branch of step S18 is that the OK key 222 has not been touched (NO in step S18), then the procedure is advanced to step S20.

In step S20, the operation portion 2 checks whether or not the protect/release key 223 on the user selection screen has been touched, and if it has been touched (YES in step S20), then the procedure is advanced to step S21. In step S21, the operation portion 2 notifies the user setting selection control portion 13 that the protect/release key 223 has been touched. The user setting selection control portion 13 receives this and checks whether a protection mark has been added to the protection mark column 161 (in the user setting storage portion 16) of the user setting that is currently selected (whose display has been inverted), and if a protection mark has been added (YES in step S21), then the procedure is advanced to step S22. In step S22, the user setting selection control portion 13 erases the protection mark from the protection mark column 161 (in the user setting storage portion 16) of the user setting that is currently selected. If it is determined at the branch of step S21 that a protection mark has not been added to the protection mark column 161 of the selected user setting (NO in step S21), then the procedure is advanced to step S23.

In step S23, the user setting selection control portion 13 checks whether a protection mark has already been written to a number of user settings that is one less than the maximum number of user settings that can be stored on the user setting storage portion 16, and if this is not the case (if the number of user settings to which a protection mark has been added is fewer than one less than the maximum number) (NO in step S23), then the procedure is advanced to step S24. In step S24, the user setting selection control portion 13 writes a protection mark to the protection mark column 161 (in the user setting storage portion 16) of the user setting that is currently selected. If it is determined at the branch of step S23 that the number of user settings to which a protection mark has been added is one fewer than the maximum number (YES in step S23), then the procedure is advanced to step S25. In step S25, the user setting selection control portion 13 displays a message on the touch panel portion 22 indicating that it is not possible for all user settings to be protected.

When it is determined at the branch of step S11 that the recall key has not been touched (NO in step S11), when the process of step S19 is finished, when the process of step S22 is finished, when the process of step S24 is finished, or when the process of step S25 is finished, the procedure is advanced to step S26.

In step S26, the operation portion 2 checks whether the start key 21 has been pressed, and if it has been pressed (YES in step S26), then the procedure is advanced to step S27. In step S27, the operation portion 2 notifies the copy control portion 17 that the start key 21 has been pressed. The copy control portion 17 receives this, reads out the setting values of the copy conditions from the setting storage portion 14, and then controls the copier machine main unit 3 to execute the copy process under these conditions. When it is determined at the branch of step S26 that the start key has not been pressed (NO in step S26), or when the process of step S27 is finished, the procedure is advanced to step S28.

Steps S28 to S30 are processes for backing up the user settings when the copier machine 1 is powered off. In step S28, the power switch portion 5 checks whether the power switch has been set to off, and if it has not been turned off (NO in step S28), then the procedure is returned to step S2 and the procedure is repeated from the process of step S2. If it is determined at the branch of step S28 that the power switch has been turned off (YES in step S28), then the procedure is advanced to step S29. In step S29, the power switch portion 5 sends a command to the end process control portion 19 to execute the end processes. The end process control portion 19 receives this, and as one end process, orders the backup control portion 18 to backup the user settings. The backup control portion 18 writes to the backup storage portion 4 those user settings that are stored on the user setting storage portion 16 to which a protection mark has not been added to the protection mark column 161. In step S30, the end process control portion 19 turns off the power to the copier machine 1 after it has performed all of the end processes.

According to this embodiment, the current copy conditions are stored in the copier machine 1 as user settings by touching the temporary save key 221, a list of the user settings is displayed by the touching the recall key 224, and user settings can be called up by selecting a preferred user setting from this list and set to the copier machine 1. Thus, user settings can be registered and recalled through fewer operations without complicating the operation portion 2.

It should be noted that the present invention is not limited to the foregoing embodiment, and can adopt the following implementations as well. The foregoing embodiment was described using a copier machine as the image forming device, but the image forming device can also be a printer or facsimile device, or a compound device that integrates those functions.

In this embodiment, a plurality of user settings are displayed on and can be selected from the user setting selection screen when the recall key 224 is touched, but it is also possible to adopt a configuration in which the user setting at the top of the list (for example, the user setting with the most recent save date) to be set to the copier machine 1 (without the operator selecting it from the selection list) when the recall key 224 is touched. It is also possible for the user setting that is to be set in the copier machine 1 to be selected based on the number of times that the recall key 224 has been touched or the duration of time that it is touched.

In the foregoing embodiment, a volatile memory is used for the user setting memory portion 16, and by using the same power system (erasing means) for the user setting storage portion 16 and the copier machine 1, the data stored on the user setting storage portion 16 is erased when the copier machine 1 is powered off, but it is also possible to use a nonvolatile memory for the user setting storage portion 16 and to erase the contents of the user setting storage portion 16 as an end process when the power is turned off.

In the foregoing embodiment, the list number 226 and the save date/time 227 are displayed as items for identifying the user settings displayed on the user setting selection screen, but the setting data, for example, may also be displayed as other identifying information. Further, in the foregoing embodiment the save date/time serves as order information that is used by the order obtaining means, but it is also possible to add a number to the user settings in the order in which they are saved and then use these numbers as order information.

What is claimed is:

1. An image forming device, comprising:
user setting storage means that stores a user setting consisting of a setting value for at least one predetermined setting field, relating to execution of an image formation job;
store command means that consists of one operation key and that is for an operator to make a command for the user setting storage means to store the user setting;
store control means for storing the user setting on the user setting storage means when a command has been received through the store command means;
display command means that consists of one operation key and that is for the operator to make a command to display identifying information of the user setting stored on the user setting storage means;
display control means for displaying the identifying information of the user setting stored on the user setting storage means when a command has been received through the display command means;
setting means for setting, to the device, the setting values included in the user setting of the identifying information displayed by the display control means; and
image formation job executing means for executing the image formation job that has been set by the setting means.

2. The image forming device according to claim 1,
wherein the display control means displays the identifying information of a plurality of the user settings when a plurality of the user settings are stored on the user setting storage means;
wherein the image forming device further comprises selection means for the operator to select one user setting from the identifying information of the plurality of user settings that are displayed by the display control means; and
wherein the setting means sets, to the device, the setting values included in the user setting that has been selected by the selection means.

3. The image forming device according to claim 1, further comprising:
erasing means for erasing the user settings stored on the user setting storage means when the image forming device is powered off.

4. The image forming device according to claim 1, further comprising:
order obtaining means for obtaining an order in which the user settings have been stored on the user setting storage means;
wherein the store control means stores the order that is obtained by the order obtaining means on the user setting storage means associated with the user settings; and
wherein the display control means displays the identifying information of the user settings sequentially, starting from the most recent user setting in the order.

5. The image forming device according to claim 4,
wherein the store control means erases the oldest user setting of the order if there is insufficient storage space in the user setting storage means when the user setting is to be stored on the user setting storage means.

6. The image forming device according to claim 4,
wherein the order obtaining means is a clock means for taking time;
wherein the storage control means stores the user settings on the user setting storage means along with a time that is taken by the clock means when the user setting is stored; and
wherein the display control means displays at least the time that is associated with that user setting as identifying information of the user setting.

7. The image forming device according to claim 5,
wherein the display control means displays the time as identifying information of the user setting, and then erases that display of the time after a predetermined period of time has elapsed.

8. The image forming device according to claim 1, further comprising:
a non-volatile protective storage means for storing the user settings stored on the user setting storage means for backup; and
a protective storage control means for causing the protective storage means to store the user settings that are stored on the user setting storage means.

9. The image forming device according to claim 1, further comprising:
erase prohibit specifying means for an operator to specify user settings that are to be prohibited from being erased by the store control means; and
adding means for adding an erase prohibit flag to the user settings that have been specified by the erase prohibit specifying means;
wherein the store control means does not erase user settings to which an erase prohibit flag has been added.

10. The image forming device according to claim 9,
wherein a maximum number of user settings to which the adding means can add an erase prohibit flag is one less than a number of user settings that can be stored on the user setting storage means.
